(19) United States
(12) Patent Application Publication
(10) Pub. No.: US 2016/0380836 A1
(43) Pub. Date: Dec. 29, 2016

(54) AUTOMATIC ESTABLISHMENT OF ANALOG NETWORK TOPOLOGY

(71) Applicant: Westell, Inc., Aurora, IL (US)

(72) Inventor: James W. Thomas, Northfield, NH (US)

(21) Appl. No.: 15/191,408

(22) Filed: Jun. 23, 2016

Related U.S. Application Data
(60) Provisional application No. 62/184,161, filed on Jun. 24, 2015.
(60) Provisional application No. 62/184,164, filed on Jun. 24, 2015.

(51) Int. Cl. H04L 12/24; H04B 10/2575; H04L 27/156; H04L 12/28; H04B 7/04

(52) U.S. Cl. CPC H04L 41/12; H04L 12/2801; H04B 7/04; H04L 27/156; H04B 10/2575

(57) ABSTRACT

A method of detecting an RF connection in a network is disclosed. The method involves the use of a low-speed modem pair DC coupled to the RF connection to modulate a DC voltage onto the RF connection. Additionally, a method of signaling over an RF-over-fiber link is provided. The method includes modulating the bias voltage of a laser with a low-bit rate signal applied through a digital-to-analog converter, which is recovered using a low-speed analog-to-digital converter.

### CROSS REFERENCE TO RELATED APPLICATIONS

This application claims the benefit of U.S. Provisional Patent Application No. 62/184,161 filed on Jun. 24, 2015, titled “AUTOMATIC ESTABLISHMENT OF ANALOG NETWORK TOPOLOGY,” and U.S. Provisional Patent Application No. 62/184,164 filed on Jun. 24, 2015, titled “OUT-OF-BAND SIGNALING OVER A FIBER OPTIC LINK,” the entire contents of which are hereby incorporated by reference herein, for all purposes.

### TECHNICAL FIELD

The present invention relates to automatic sensing of connections in a network, particularly in analog RF distribution networks. The present invention also relates generally to the exchange of signaling information in an RF-over-fiber link, and in particular, the exchange of signaling information over the optical transport link used in in-building distributed antenna systems (DAS) to connect head-ends to remote units.

### BACKGROUND OF THE INVENTION

RF distribution networks often involve connections between physically distant nodes. By way of example, in an RF-over-fiber distribution network between a DAS head-end (HE) and a DAS remote unit, head-end transceivers will typically be located on a building rooftop within line-of-sight of one or more cellular base stations, and remote units (RUs) will be distributed throughout a building. In certain installations, multiple head-ends, corresponding to different wireless service providers, may share the same RUs. Ensuring proper cabling (i.e., proper connection between the HEs and the RUs) or detecting cable connection failures in such circumstances can be challenging.

### SUMMARY OF THE INVENTION

The invention is directed to a method for detecting a user connection in an RF network. Embodiments of the invention include providing a first low-speed modem DC coupled to a first node connected to a first side of a user connection; providing a second low-speed modem DC coupled to a second node connected to a second side of a user connection; and with the first low-speed modem, modulating a DC voltage onto the user connection and detecting the modulated DC voltage using the second low-speed modem.

Embodiments of the invention further include using a digital-to-analog converter (DAC) and analog-to-digital converter (ADC) pair as the first modem, and using a second digital-to-analog converter (DAC) and analog-to-digital converter (ADC) pair as the second modem. Another embodiment of the invention includes using integrated circuits implementing a dial-up modem standard as the first and second modems.

In certain embodiments, where the modems do not have full duplex capability, the first node comprises an RF output and the first low-speed modem comprises a digital-to-analog converter (DAC), and the second node comprises an RF input and the second low-speed modem comprises an analog-to-digital converter (ADC). Further, the DC voltage may be modulated onto the user connection with pulse-width modulation, where a 20% modulation represents a binary 0, an 80% modulation represents a binary 1, and a 50% modulation represents a frame bit. Additionally, a part of the modulated DC voltage detected by the second low-voltage modem may comprise a 16 bit node ID.

Embodiments of the invention also provide a method for signaling over an RF-over-fiber link at a low bit-rate without interfering with the payload signal going across the fiber. This method of providing signaling over an RF-over-fiber link having a laser, an optical fiber, and an optical detector, where the RF-over-fiber link carries an RF payload signal, includes providing a digital to analog converter in electronic communication with the bias voltage of the laser such that the bias voltage of the laser is modulated with a low bit-rate signal, such that the low bit rate signal is present optically on the optical fiber; receiving the low bit rate signal and the RF payload signal with an optical detector which converts the combined signal into an electrical combined signal; and providing a low speed analog-to-digital converter that monitors the low bit-rate signal.

In certain embodiments, the low bit-rate signal is modulated with pulse-width modulation, where a 20% duty cycle represents a binary 0, an 80% duty cycle represents a binary 1, and a 50% duty cycle represents a frame bit. Further, in certain embodiments, a part of the low bit-rate signal monitored by the low speed analog-to-digital converter comprises a 16 bit node ID.

Embodiments of the invention have certain advantages, for example, the invention allows an installer or configurer of an RF network to determine the connectivity between network nodes, because the invention enables the user to verify that the system has been connected as intended. Additionally, embodiments of the invention allow the system to make this check automatically and alert the user to the existence of cabling problems. Further, embodiments of the invention allow the system to optimize the gain of its constituent elements to balance user demands on the network and to provide maximum dynamic range and noise performance.

The ability provided by the invention to automatically determine network connectivity, and even to dynamically and automatically build network maps, obviates the need to verify connectivity via manual inspection of the system, which becomes more difficult as the number of connections increases or the connections span distances which do not allow the installer to see both ends of the connection at the same time.

Embodiments of the invention are particularly advantageous where connectivity is established in the field by the end-user because the user's eventual configuration cannot be known a priori. If the system is already in operation when connectivity is changed, determining the network topology without disturbing the operation of existing nodes can also be problematic. Embodiments of the invention are especially useful in systems that bond multiple channels together to form MIMO channels, because upper-level protocols are typically unaware that the network connection has been implemented over multiple physical channels. Embodiments of the invention described herein solve the above identified problems by automatically establishing the RF network topology.

Additionally, in an RF-over-fiber optic system, it is sometimes necessary to exchange signaling information between two nodes (e.g., a head-end and a remote unit), for example, to check connectivity, for handshaking, and other purposes. Embodiments of the invention described herein advantageously accomplish this without consuming undue amounts of bandwidth or using up the dynamic range of the RF-over-fiber link.

### BRIEF DESCRIPTION OF THE DRAWINGS

The invention will be more fully understood by referring to the following Detailed Description of Specific Embodiments in conjunction with the Drawings, which are embedded in the Detailed Description below.

FIG. 1 shows a network modeled as a directed graph.

FIG. 2 shows an arrangement for detecting a user provided connection in an RF network using two low-speed modems, according to an embodiment of invention.

FIG. 3 is a schematic representation of an RF-over-fiber link including provision for low-speed modulation of a laser's bias voltage according to an embodiment of the invention.

FIG. 4 is a flowchart of an operational sequence for automatically detecting cable connections in a network according to an embodiment of the invention.

FIG. 5 is a schematic representation of a DAS system utilizing embodiments of the invention.

### DETAILED DESCRIPTION OF SPECIFIC EMBODIMENTS

A detailed description of preferred embodiments of the invention is set forth below.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

In addition, the following disclosure may describe features of the invention with reference to corresponding drawings, in which like numbers represent the same or similar elements wherever possible. In the drawings, the depicted structural elements are generally not to scale, and certain components are enlarged relative to the other components for purposes of emphasis and understanding. It is to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed.

Networks are commonly modeled as directed or undirected graphs. Each vertex in the graph represents a node in the network, and each edge in the graph represents a connection between nodes. Each node and edge in the graph is assigned a numeric identifier which is unique across the system.

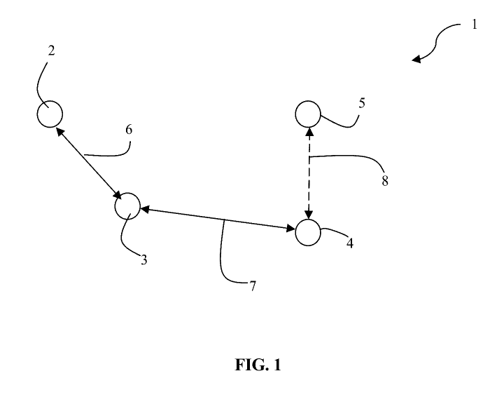

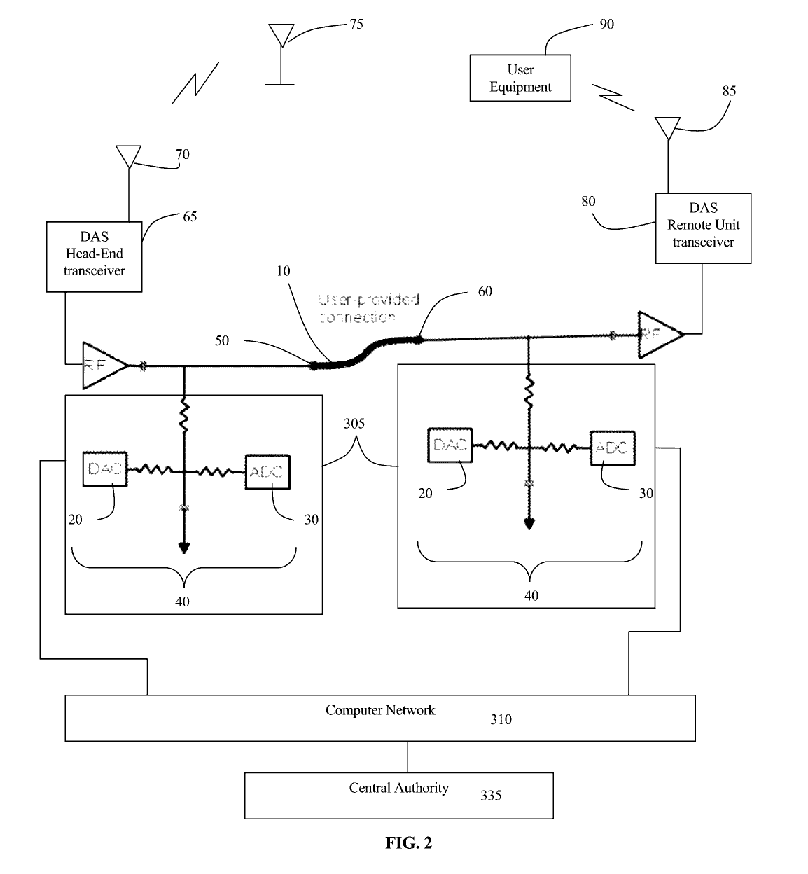

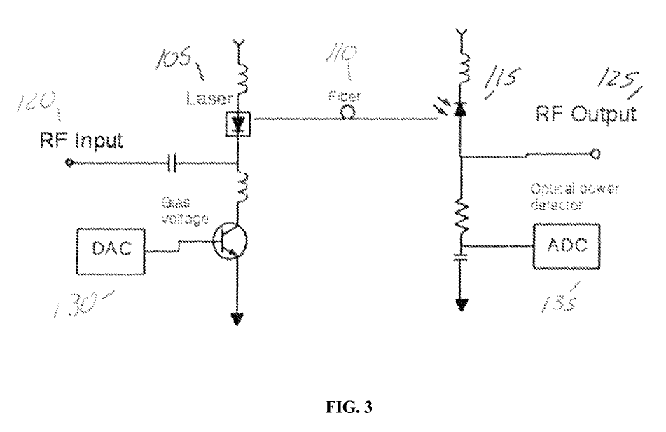

Computational or logical modules in the system are connected via a computer network which may or may not be distinct from the analog RF network. These modules create nodes in the graph, and request node identifiers for themselves from the system's central authority (such as a database). Each module in the system may have multiple nodes, and that component will also know how those nodes are interconnected. These computational components will tell the system's central authority to establish edges between its internal nodes. Each module in the RF network (i.e., the physical network) may have one or more nodes representing the external connectors located typically on the module's front panel. FIG. 1 schematically depicts a network 1 with nodes 2, 3, 4, 5 and edges 6, 7, 8. Edge 8, which connects nodes 4 and 5, is shown with a dashed line because it has not yet been detected by the system. Embodiments of the invention for detection of the connection are described with respect to FIGS. 2 and 3 below.

Embodiments of the invention enable detection of a connection between modules by providing a DC-coupled path from the connector on a module to a low-speed modem. Examples of low-speed modems include dial-up modem standards, for example Bell 103, V.21, and V.90. An exemplary embodiment is set forth in FIG. 2, which shows an arrangement for providing communication between two low-speed modems 40 over a user provided connection 10, according to an embodiment of invention. The embodiment set forth in FIG. 2 shows an embodiment of the invention implemented in a DAS system which generally comprises a DAS head-end transceiver 65 with an antenna 70 which communicates wirelessly with an eNodeB (e.g., a cell tower) 75. The DAS system also comprises a remote unit transceiver 80 with an antenna 85 which communicates wirelessly with user equipment (e.g., a cell phone) 90. The low speed modems 40 may be contained within a module 305 which also contains computer device equipment (not shown). The modules 305 are connected via a computer network 310 which connects a central authority 335 running a database.

In the implementation of FIG. 2, the modem 40 is realized using a simple, low-speed digital-to-analog converter (DAC) 20 and analog-to-digital converter (ADC) 30 pair, which are DC-coupled to connectors 50, 60. The modulation and demodulation, in the exemplary embodiment shown in FIG. 2, are accomplished in software using pulse-width modulation to convey three distinct states (20% modulation represents a binary 0, 80% represents a binary 1, and 50% represents a frame bit to delineate the word boundaries).

Alternate designs include an integrated circuit implementing a dial-up modem standard used in place of the DAC-ADC pair. Alternative embodiments employ a software implementation of the modulation (using the DAC) or demodulation (using the ADC). This alternate implementation is discussed in greater detail below.

The modem's analog I/O is low-pass filtered so that the RF signal carried on the connection (i.e., the data being transported) is significantly attenuated and does not disrupt the operation of the modem 40. Because the modem 40 is DC-coupled to the connector, it may modulate DC voltages onto the RF line which may be detected at the other end by the remote module's demodulator. The AC coupling between the RF and the connector eliminates the interference caused by the low-speed modem 40.

Using this circuitry in place, a module broadcasts information to anything that is connected to it. In certain embodiments, the information is the node ID of the node (encoded in binary) representing the connector as assigned by the central authority. One or more remote modules receive, and attempt to demodulate and decode the broadcast signal, in order to determine the ID of the broadcasting node. If a received signal has been successfully demodulated, the broadcasting node is identified, and the receiving module contacts the central authority to establish node connectivity between itself and the broadcaster. In the exemplary embodiment shown in FIG. 2, a frame bit is modulated at the beginning of the broadcast of the node ID which may be, for example, 16 or 32 bits long.

If the low-speed modem does not support full-duplex operation, this approach requires that only one node broadcast to a connection at a time. In the reference implementation, connectors operating as RF outputs would broadcast, and connectors operating as RF inputs would demodulate.

As long as the system is cabled such that only one RF output drives any given connection, this approach allows simultaneous detection of the connectivity for the entire system. If two broadcasters (in the reference case, the RF outputs) are connected together, the system will not detect a valid connection, as the two modulators will interfere with one another.

When the receiver detects the node ID of the broadcaster, it contacts the central authority to effect a connection represented as an edge in the graph. The only information it needs to accomplish this is the node ID of its receiver and the node ID broadcast to it. Error checking can be implemented using any suitable error-detection scheme such as parity checks, Hamming codes, or the like.

Further reduction in erroneous connections may be achieved by establishing node types for cable-detect transmitters and cable-detect receivers which are distinct from other node types in the system, so that those nodes in the system that would not be expected to establish automatic connections would not be permitted to do so.

Because this approach does not interfere with the RF performance of the system, it may be implemented continuously during system operation. This allows the system to detect service disruption caused by a failed cable, or by an unintentional act on the part of the user. It also allows the system to detect intentional changes to the network topology and react accordingly.

The arrangement for detecting a connection according to embodiments of the invention have certain advantages. For example, in an analog RF distribution network, it is beneficial to determine the connectivity between network nodes, because it enables the user to verify that the system has been connected as intended. Additionally, provision for the automatic detection of the connectivity between network nodes can alert the user to the existence of cabling problems. Additionally, embodiments of the invention also allow the system to optimize the gain of its constituent elements to balance user demands on the network and to provide maximum dynamic range and noise performance.

Non-interfering signaling of the sort described above can also be achieved in a system employing an RF-over-fiber link. Thus, alternative embodiments of the invention are directed to providing signaling over an RF-over-fiber link at a low bit-rate without interfering with the payload signal going across the fiber. This is accomplished by providing a facility for adjusting the laser's bias voltage, and circuitry at the receiving end to detect the modulated optical power level.

With these provisions, the transmit equipment applies low-level, low-speed (i.e., audio frequency or lower) modulation to the laser's bias voltage, and that signal can be detected on the receiving end by the optical power detection circuitry. As long as the modulator's carrier frequency is sufficiently low, this signal will not affect the operation of the in-band RF signal being transmitted over the fiber. It will have a small impact on the amount of dynamic range available to the signal of interest, but this can be mitigated by reducing the depth of modulation on the signaling carrier, by only transmitting signaling information during “quiet” times (such as during system initialization, or when the system is seeing a low amount of use), or both.

FIG. 3 schematically depicts an arrangement for providing for signaling over an RF-over-fiber link according to an embodiment of the invention. As can be seen in FIG. 3, an RF-over-fiber link is provided including a laser 105, a fiber 110, and an optical detector 115. Laser 105 is modulated by means of RF Input 120 to carry a payload signal, which is transported over fiber 110, detected by detector 115 (e.g., a photodiode), resulting an in RF output 125. In one embodiment of the invention, the bias voltage of laser 105 is modulated with a slow (i.e., low bit rate) signal outputted by digital-to-analog converter (DAC) 130, which signal is then detected at analog-to-digital converter (ADC) 135.

In a particular embodiment of FIG. 3, the low bit-rate signaling is accomplished by using pulse width modulation. A 20% duty cycle is used to represent a binary 0, an 80% duty cycle is used to represent a binary 1, and a 50% duty cycle is used as a frame bit to delineate word boundaries. The bias voltage is set using a low-speed digital-to-analog converter (DAC), and the optical power on the receive-side is monitored with a low-speed analog-to-digital converter (ADC). Modulation and demodulation is accomplished in software with the bias voltage being modulated by adjusting the bias voltage by ±3%.

The approach described herein provides one-way transmission of low-bandwidth signaling data from the transmitter to the receiver. Conventionally, signaling over an RF-over-fiber link is accomplished by implementing high-bandwidth modulation schemes (such as wi-fi) over the fiber. Embodiments of the invention have advantages over this conventional approach because they are realized with less costly equipment, do not require wi-fi capability at both ends of the fiber optic link, and eliminate the possibility of the modulated signal interfering with the payload signal.

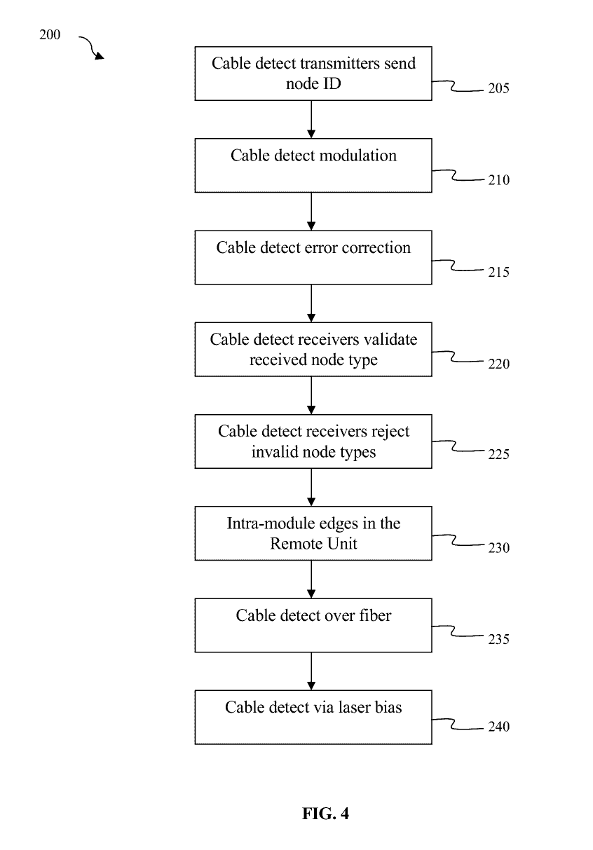

FIG. 4 is a flowchart of an operational sequence for automatically detecting cable connections in a network according to an embodiment of the invention. The method, or operational sequence, for automatically detecting cables shown in FIG. 4 utilizes both of the approaches to connection detection as described in relation to FIGS. 2 and 3. This method is described in terms of an in-building distributed antenna system (DAS), but could be employed for various different networks. The DAS shall generate directed graphs representing the RF connectivity throughout the system. The directed graphs will be stored in the DAS database.

The sequence 200 begins with step 205, where all modules in the network with cable detection hardware transmit the node ID (i.e., in the directed graph) of each cable detection node. Step 210 indicates that the node id transmission over the cable detect hardware will be accomplished by using pulse width modulation to send a 16-bit node ID plus a frame bit.

In step 215, the cable detect transmissions may transmit additional bits to serve as an error detection function (such as a Hamming code). Step 215 is optional. In step 220, when a cable detect receiver successfully demodulates a received node ID, it will verify that the received node ID represents a cable detect transmit node in the database graph before adding it to the graph.

In step 225, if the node ID demodulated by a cable detect receiver is not a cable detect transmitter, the receiver will disregard it and continue looking for a valid node ID. In step 230, RF connections between modules within the remote unit will be fixed, and if the modules are detected in the system, the detected modules will be added to the directed graph. In steps 235 and 240, the automatic cable detect is performed over the fiber optic cables. Optical transmitters will use the same pulse width modulation (PWM) algorithm to transmit a node ID as the other cable detect hardware, but will modulate the laser bias to achieve this. Receivers will detect bias modulation with optical power detectors.

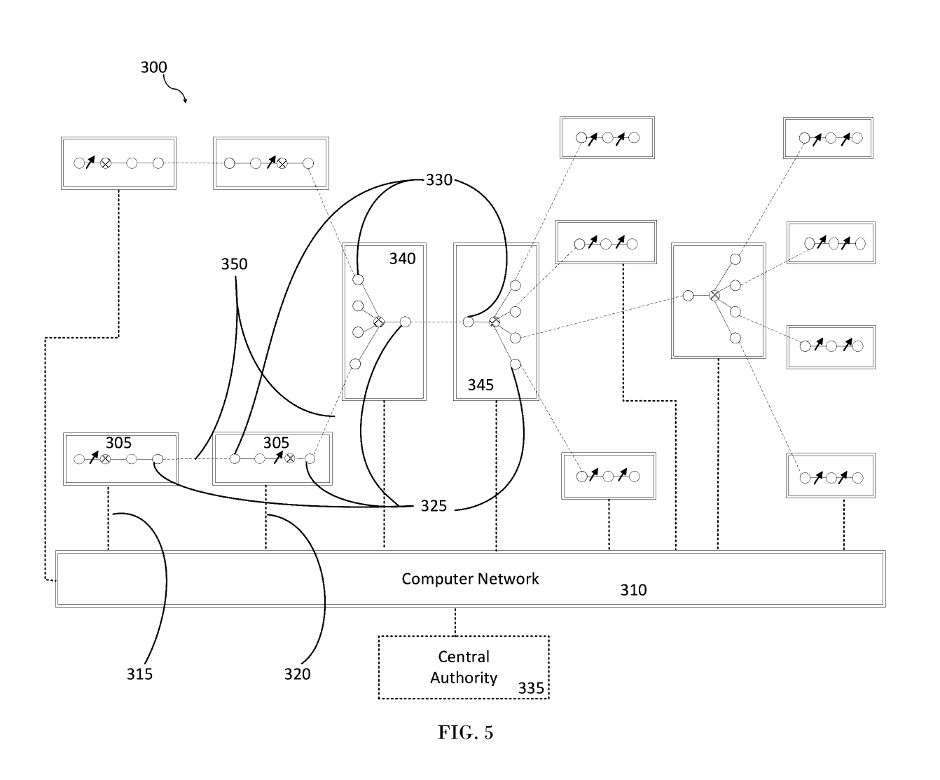

FIG. 5 is a schematic representation of a DAS system 300 utilizing embodiments of the invention. The DAS system 300 generates directed graphs representing the RF connectivity throughout the system. The directed graphs are stored in the DAS database. Computational or logical modules 305 each contain a computer device and are connected via a computer network 310. The computer network connections may consist of a mix of Ethernet connections 315 and/or wi-fi over optic fiber connections 320. The modules 305 may include cable detect transmitter nodes 325, cable detect receiver nodes 330, or a combination of both. The cable detect transmitter nodes 325 and the cable detect receiver nodes 330 each have a unique node ID. The modules 305 create nodes in the graph, and request node identifiers for themselves from the system's central authority 335 which runs the DAS database where all the graph information is stored, which includes the cable detect nodes 325, 330 and the detected edges 350. Further, each module 305 in the system may have multiple nodes, and will also know how those nodes are interconnected, as illustrated by centrally located modules 340, 345. The modules 305 communicate via the computer network 310 and instruct the system's central authority 335 to establish edges between its internal nodes.

Utilizing the cable detect methods described in relation to FIGS. 2 and 3, above, a module 305 broadcasts the node ID of its cable detect transmitter nodes 325 (encoded in binary). Once another module 305 receives and demodulates the broadcast node ID, the cable detect transmitter node 325 is identified, and the receiving module contacts the central authority 335 to establish node connectivity between itself and the broadcaster, thereby indicating a detected edge 350. The only information the receiving module needs to accomplish this is the node ID of its cable detect receiver node 330 and the node ID broadcast to it. The method used to detect the connection will depend on whether the modules are connected via an optical fiber or copper.

While the preferred embodiments of the present invention have been illustrated in detail, it should be apparent that modifications and adaptations to those embodiments may occur to one skilled in the art without departing from the scope of the present invention.

What is claimed is:

1. A method for detecting a user connection in an RF network, comprising:
providing a first low-speed modem DC coupled to a first node connected to a first side of a user connection;
providing a second low-speed modem DC coupled to a second node connected to a second side of a user connection;
with the first low-speed modem, modulating a DC voltage onto the user connection and detecting the modulated DC voltage using the second low-speed modem.

2. The method of claim 1, wherein the first low-speed modem comprises a first digital-to-analog converter (DAC) and analog-to-digital converter (ADC) pair, and wherein the second low-speed modem comprises a second digital-to-analog converter (DAC) and analog-to-digital converter (ADC) pair.

3. The method of claim 1, wherein the first low-speed modem comprises a first integrated circuit implementing a dial-up modem standard, and wherein the second low-speed modem comprises a second integrated circuit implementing a dial-up modem standard.

4. The method of claim 1, wherein the first node further comprises an RF output and the first low-speed modem comprises a digital-to-analog converter (DAC), and wherein the second node further comprises an RF input and the second low-speed modem comprises an analog-to-digital converter (ADC).

5. The method of claim 1, wherein the DC voltage is modulated onto the user connection with pulse-width modulation, wherein a 20% modulation represents a binary 0, an 80% modulation represents a binary 1, and a 50% modulation represents a frame bit.

6. The method of claim 1, wherein a part of the modulated DC voltage detected by the second low-voltage modem comprises a 16 bit node ID.

7. The method of claim 6, further comprising:
reporting the 16 bit node ID to a central authority.

8. The method of claim 7, further including building a network topology on the basis of reports provided to the central authority.

9. The method of claim 1, wherein the step of modulating a DC voltage onto the user connection is performed such that the modulated DC voltage does not interfere with an RF data payload on the user connection.

10. The method of claim 1, wherein the step of detecting the modulated DC voltage using the second low-speed modem includes low pass filtering the input of the second low-speed modem such that any RF data payload signal at the second low-speed modem's input is attenuated and does not disrupt the operation of the second low-speed modem.

11. A method of providing signaling over an RF-over-fiber link having a laser, an optical fiber, and an optical detector, the RF-over-fiber link carrying an RF payload signal, the method comprising:
providing a digital to analog converter in electronic communication with the bias voltage of the laser such that the bias voltage of the laser is modulated with a low bit-rate signal, such that the low bit rate signal is present optically on the optical fiber;
receiving the low bit rate signal and the RF payload signal with an optical detector which converts the combined signal into an electrical combined signal;
providing a low speed analog-to-digital converter monitoring the low bit-rate signal.

12. The method of claim 11, wherein the low bit-rate signal is modulated with pulse-width modulation, and wherein a 20% duty cycle represents a binary 0, an 80% duty cycle represents a binary 1, and a 50% duty cycle represents a frame bit.

13. The method of claim 11, wherein a part of the low bit-rate signal monitored by the low speed analog-to-digital converter comprises a 16 bit node ID.

14. A DAS system comprising:
a head end transceiver with a first antenna;
a remote unit transceiver with a second antenna;
a central authority connected to the DAS system through a computer network;
a first low-speed modem DC coupled to a first node connected to a first side of a user connection, wherein the first low-speed modem modulates a DC voltage onto the user connection; and
a second low-speed modem DC coupled to a second node connected to a second side of a user connection, wherein the second low-speed modem detects the modulated DC voltage.

15. The system of claim 14, wherein the first low-speed modem comprises a first digital-to-analog converter (DAC) and analog-to-digital converter (ADC) pair, and wherein the second low-speed modem comprises a second digital-to-analog converter (DAC) and analog-to-digital converter (ADC) pair.

16. The system of claim 14, wherein the first low-speed modem comprises a first integrated circuit implementing a dial-up modem standard, and wherein the second low-speed modem comprises a second integrated circuit implementing a dial-up modem standard.

17. The system of claim 14, wherein the first node further comprises an RF output and the first low-speed modem comprises a digital-to-analog converter (DAC), and wherein the second node further comprises an RF input and the second low-speed modem comprises an analog-to-digital converter (ADC).

18. The system of claim 14, wherein the DC voltage is modulated onto the user connection with pulse-width modulation, wherein a 20% modulation represents a binary 0, an 80% modulation represents a binary 1, and a 50% modulation represents a frame bit.

19. The system of claim 14, wherein a part of the modulated DC voltage detected by the second low-voltage modem comprises a 16 bit node ID.

20. The system of claim 19, wherein the 16 bit node ID is reported to the central authority, and a network topology is created on the basis of reports provided to the central authority
